(19) United States
(12) Patent Application Publication
(10) Pub. No.: US 2021/0054687 A1
(43) Pub. Date: Feb. 25, 2021

(54) Flexible Door Privacy Screen

(71) Applicant: Daniel Sievers, Hudsonville, MI (US)

(72) Inventor: Daniel Sievers, Hudsonville, MI (US)

(21) Appl. No.: 16/997,822

(22) Filed: Aug. 19, 2020

Related U.S. Application Data
(60) Provisional application No. 62/922,695, filed on Aug. 23, 2019.

(51) Int. Cl. E06B 7/36; E06B 7/16

(52) U.S. Cl. CPC E06B 7/367; E06B 7/16

(57) ABSTRACT

According to the present invention a bellows formed of a plurality of articulating connected panels when correctly installed substantially obscure the line of sight through the gap created at the hinge-end edge surface of an ajar door, and whose closed folds come together one on another and remain substantially in the space between a door hinged-end edge surface and its door jamb when the door is closed (this space can alternatively be called a hinge gap, cavity or rabbet) whereby the appearance of the flexible door privacy screen arrangement is as unobtrusive as possible.

### CROSS-REFERENCE TO RELATED APPLICATIONS

Provisional patent application No. 62/922,695; Filing Date Aug. 23, 2019

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

### Field of the Invention

This invention relates to door privacy screens and, more particularly, to screens for blocking lines of sight through the gap formed between a door jamb and a hinged-end of a door as the door is closed or opened, or at any position in between.

References Cited

| | | |
|---|---|---|
| 4,040,142 | August, 1977 | Ippolito |
| 4,845,892 | July, 1989 | Pinto |
| 4,878,267 | November, 1989 | Roach |
| 6,141,909 | November, 2000 | Hanson |
| 7,861,465B1 | January, 2011 | Christ |
| 8,342,593B2 | January, 2013 | Ruby |
| 9,803,419B2 | October, 2017 | Izod |

### BRIEF SUMMARY OF THE INVENTION

### Background of the Invention

In many environments, it is desirable to prevent persons from viewing the inside of a room through the gap formed between the hinged-end of a door and its door jamb. Occasionally, some doors are designed such that there is a small crack, or space, which allows for visibility through the hinge gap (or alternatively called a cavity or rabbet), between the hinged-end of a door and its door jamb even when a door is in a substantially closed position. However, it is more often the case that a gap between the hinged end of a door and its door jamb is created and becomes wider as a door is moved to an increasingly open position.

An environment where privacy is of concern is that of the hospital or medical office setting. To this effect, many examination rooms are built with doors that are located near one of the extreme ends of the examination room and have their hinged end on the side of a door nearest the middle of the room. With this arrangement, the door opens to a view of the side wall of the examination room. Thus, in an attempt to retain privacy as a door is opened to allow the health care provider to enter or leave, the patient and examination furniture and tools are located behind the door.

Occasionally the examination room door is not fully closed while the patient is in the room preparing for an exam, allowing passers-by looking at the edge of a door with the door handle only a partial view of the inside of the examination room side wall. Nonetheless, even with this door placement, a visual line of sight into the examining room through the gap between the hinged-end of a door and its door jamb is provided at any point that the door is in the ajar position. The visibility through this gap providing a line of sight inside to passers-by can cause a breach of privacy, possibly cause an infraction of privacy laws, and additionally cause the patient to feel embarrassed or uncomfortable, which often hampers the effectiveness of their examination and treatment.

In addition to health care, other settings in which obscuring the gap providing a line of sight into an area created at the hinged-end edge of a door and its door jamb as the door is opened include business offices, restrooms and bathroom stalls, bedrooms, conference rooms and any other settings where privacy is desired. Consequently, the need for inhibiting the ability to see what is on the other side of the door at the junction of the hinged-end edge of a door and its door jamb is substantial.

Previous devices which incidentally can cover the line of sight through the hinge gap area have been in use for years. Although most are aimed at the prevention of fingers being accidently pinched in the hinge gap area, unlike this invention, these designs do not have the ease of use and installation, cost effectiveness as well as being substantially unobtrusive by being mostly contained in the hinge gap cavity virtually out of sight when a door is closed.

These previous products have been complicated, as in the design of U.S. Pat. No. 4,878,267, expensive as in the design of U.S. Pat. No. 4,040,142, or both as seen in U.S. Pat. No. 6,141,909. Among devices that are meant to be applied to existing door systems, such as U.S. Pat. Nos. 4,845,892 and 9,803,419 B2, many involve significant alterations to door jambs and doors, or destruction of the doors' decorative finish which could result in a door needing replacement if the device is removed. As a result, there has been a long-felt need for a simple, inexpensive flexible door privacy screen that can easily be applied to existing door systems. This present invention is directed to satisfying this need.

### BRIEF DESCRIPTION OF SEVERAL VIEWS OF THE DRAWING

### Brief Description of the Drawings

The foregoing and other features and advantages of the present invention will become more easily appreciated as the same becomes better understood by reference to the following drawings and a detailed description of the preferred embodiment of the invention wherein:

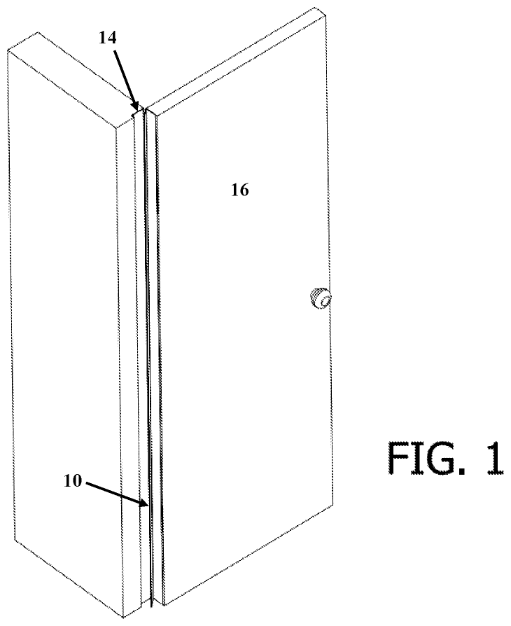

FIG. 1 is a perspective view of a door and wall section with door jamb having a flexible door privacy screen installed in accordance with the invention;

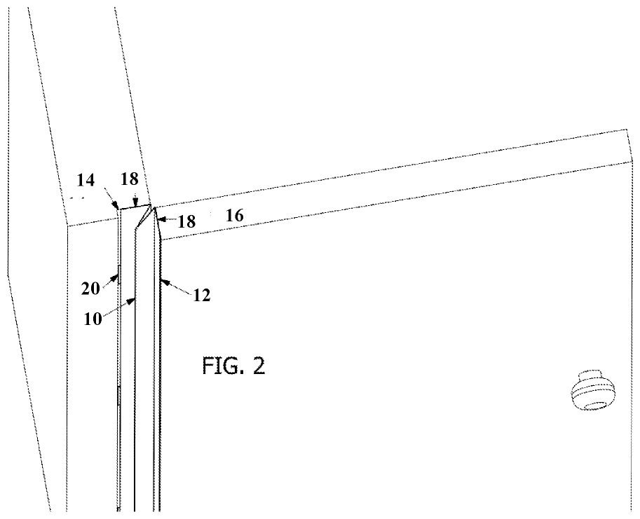

FIG. 2 is an enlarged view of a portion of FIG. 1;

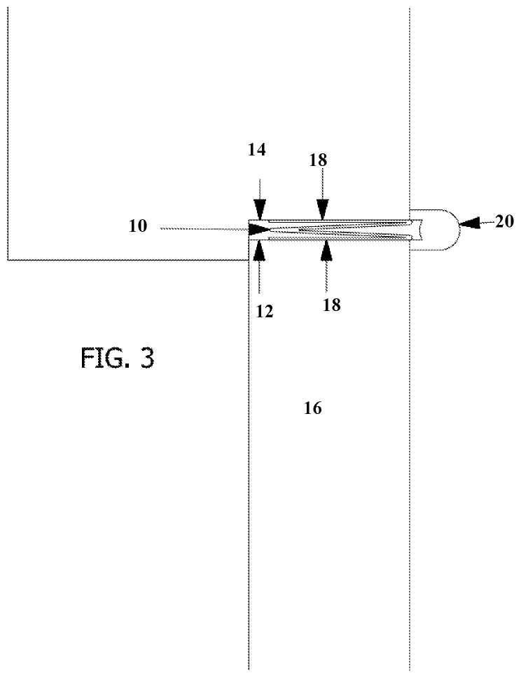

FIG. 3 is a top view of a door with the wall and door jamb in section of an installed flexible door privacy screen when the door is in the closed, near zero degree position;

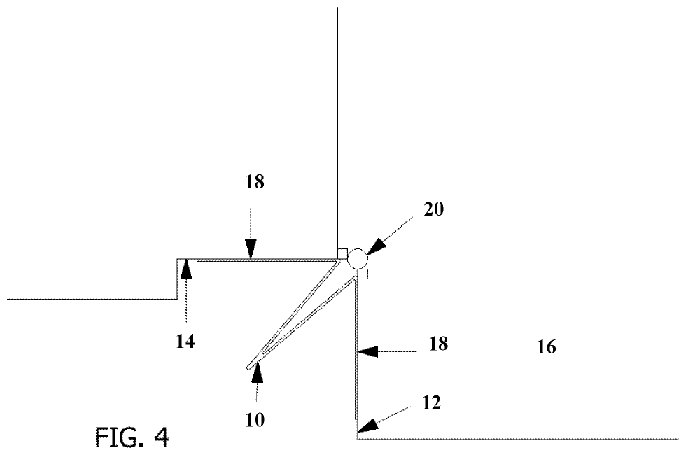

FIG. 4 is a top view of a door with the wall and door jamb in section of an installed flexible door privacy screen when the door is in the opened, near 90-degree position.

### DETAILED DESCRIPTION OF THE INVENTION

In accordance with the invention, a flexible door privacy screen for blocking most lines of sight through the gap formed between the hinged-end edge of a door and its door jamb is disclosed. The flexible door privacy screen includes a pleated material that is affixed to the hinged-end edge of a door and its facing area on its door jamb that is somewhat parallel when a door is closed. This configuration allows for the flexible door privacy screen the minimum protrusion possible outside the space comprised of the gap between the hinged-end edge of a closed door and its door jamb. This gap can also be described as a hinge gap, cavity or rabbet. The flexible door privacy screen is folded, or extruded, in a concertinaed pattern, or accordion pleat, which allows the privacy screen to change its shape, or have its pleats move to allow the screen's overall width to increase, much like a moving bellows, as the door is opened while still retaining the function of blocking most lines of sight into a room on the other side of the door. Conversely, as a door is closed the concertinaed, accordion pleat shape allows the folds to come together one on another allowing for many articulations without damage to the flexible door privacy screen. With this configuration the flexible door privacy screen achieves the desired result which is to block most lines of sight through the gap between the hinged-end edge of a door and its door jamb while the door is in its closed, or open positions, and while the door is moved between the open or closed positions. In accordance with other aspects of this invention the flexible door privacy screen is adhered to the hinged-end edge surface of a door and the surface of its door jamb that is somewhat parallel to the hinged-end edge when a door is closed, respectively through the use of double-sided tape affixed on the outermost surfaces of the flexible door privacy screen, or by using some other fastening device.

### Description of the Preferred Embodiment

FIG. 2 Illustrates a preferred embodiment of an installed flexible door privacy screen 10 formed in accordance with the invention. When in place, the flexible door privacy screen 10 blocks most lines of sight through the space, or gap, between the hinged-end edge of a door 12 and its door jamb 14. The flexible door privacy screen is adhered to the hinged-end edge surface 12 of a door 16 and its door jamb surface 14. The flexible door privacy screen 10 can be installed in whatever length is desired; a partial length or the entire length of the hinged-end edge surface 12 of a door 16 and its door jamb surface 14 with no interruption needed, having the ability to cover, if desired, both hinge mounting plates 20 as well as the door 16 hinged-edge edge surface 12. The flexible door privacy screen 10 is adhered through the use of double-sided tape 18 affixing the flexible door privacy screen 10. The assembled and mounted flexible door privacy screen is of thickness that allows the folded bellows shape to substantially fit within the narrow space, or cavity, between the hinged-end edge of a door 12 and its door jamb 14 when the door is in the closed position, as shown in FIG. 3. While a preferred embodiment of the invention has been illustrated and described, it should be understood that variations can be made therein without departing from the spirit and scope of the invention. For example, any adhesive or mechanical means of attachment (i.e. glue, contact cement, nails, screws, staples, etc.) may be used to adhere the flexible privacy screen. Although the preferred embodiment uses a single folded, or extruded thermoplastic piece; a textile, paper, or a combination of materials may be assembled to act in the same way as a single piece (such as paper and plastic together.)

What is claimed is:

1. What is claimed is a flexible privacy door screen consisting of a concertinaed, or bellows, shape formed of a plurality of connected articulating panels affixed to the relatively parallel surfaces a door and its door jamb form when the door are in the relatively closed position; this configuration allows for the articulating panels to change angles through the entire range of motion of a door while remaining affixed, whereby obscuring the changing width line of sight created at the hinge-end edge surface of an ajar door; as the door is closed the articulating panels come together one on another and are of a thickness where they remain substantially in the space, (alternatively called a hinge gap, cavity, or rabbet) between a door hinged-end edge surface and its door jamb when a door is closed and the hinged-end edges are substantially parallel.

2. The flexible privacy door screen in claim 1 is constructed from a thermoplastic material allowing for multiple articulations.

3. The flexible privacy door screen in claim 1 is constructed of a textile or paper material.

4. The flexible privacy door screen in claim 1 is affixed using double sided tape
